(19) United States
(12) Patent Application Publication
(10) Pub. No.: US 2009/0259453 A1
(43) Pub. Date: Oct. 15, 2009

(54) Method of modeling SRAM cell

(76) Inventors: Vineet Wason, Santa Clara, CA (US); Ciby Thuruthiyil, Fremont, CA (US); Priyanka Chiney, Sunnyvale, CA (US); Qiang Chen, Cupertino, CA (US); Sriram Balasubramanian, Fremont, CA (US)

Correspondence Address: HAMILTON & TERRILE, LLP - AMD, P.O. BOX 203518, AUSTIN, TX, 78720, US

(21) Appl. No.: 12/082,533

(22) Filed: Apr. 11, 2008

(51) Int. Cl. G06F 17/50

(52) U.S. Cl. 703/15; 703/14

(57) ABSTRACT

A method of modeling an SRAM cell is provided. Initially, transistor models are provided based on transistor devices, and an SRAM cell model is provided including the transistor models. The present methodology streamlines the modeling process by modeling in order the pull up, pass gate and pull down transistors so as to minimize the number of transistor modeling iterations needed, and by focusing on the specific areas of transistor operation to achieve the desired level of operational accuracy. Variations to the model are provided, mimicking variations in data from actual devices, and yield based on failure estimation is measured using the model and its variations.

### BACKGROUND OF THE INVENTION

1. Field of the Invention

This invention relates generally to a six-transistor static random access memory (SRAM) cells, and more particularly, to SRAM metric driven transistor model extraction.

2. Discussion of the Related Art

FIG. 1 is a schematic illustration of an SRAM cell 20, each cell being capable of holding one bit of information. As such, the SRAM cell includes a pair of pull up transistors P1, P2, a pair of pull down transistors N1, N3, and a pair of pass gate transistors N2, N4 connected as shown, all as is well known. In an SRAM cell 20, both the logical bit and its complement are stored through a cross-coupled inverter, made up of pull up and pull down transistors, in a bistable configuration. The cell operates as follows. Assume that the content of the memory cell is a 1, stored at Q. The read cycle is started by precharging both the bit lines BL, B̅L̅ to a logical 1, then asserting the Word Line, enabling both the pass gate transistors N2, N4. The second step occurs when the values stored in Q and Q̅ are transferred to the bit lines BL, B̅L̅ by leaving BL at its precharged value and discharging B̅L̅ through N3 and N4 to a logical 0. On the BL side, the transistors P1 and N2 pull the bit line toward V_{DD}, a logical 1. If the content of the memory was a 0, the opposite would happen and B̅L̅ would be pulled toward 1 and BL toward 0. The difference in BL and B̅L̅ is used to ascertain the value of the bit stored in the SRAM cell 20.

If we wish to write a 0, we would set B̅L̅ to 1 and BL to 0. This is similar to applying a reset pulse to a SR-latch, which causes the flip flop to change state. A 1 is written by inverting the values of the bit lines. WL is then asserted and the value that is to be stored is latched in.

In modern devices including complex circuitry, an array of these SRAM cells 20 may make up a substantial portion of the overall integrated circuitry. It is highly desirable that prior to actual manufacture of the device including such an SRAM memory array, an accurate operational model of such a cell be provided, with the ultimate goal of predicting the characteristics of the manufactured cell.

A typical approach in modeling an SRAM cell starts with the modeling of the transistors thereof. For example, in modeling a pull up transistor, using selected data (for example current-voltage (IV) operational characteristics) taken from an actual pull up transistor to be modeled, one loads this data into a software program which also contains a (public domain) transistor model. Parameters of the transistor model are then varied with the goal of having the model operational characteristics match those corresponding operational characteristics of the actual transistor.

In FIG. 2, the squares (greatly reduced in number for clarity) illustrate data for an actual pull up transistor to be modeled, showing actual drive current Idrive vs. steps in drain voltage Vds at various values of gate voltage Vgs. The goal is to provide a pull up transistor model which has operational characteristics which substantially match this data. As stated above, to achieve this, parameters of the transistor model are varied until “best” matches (illustrated by the continuous lines) are provided to the actual data.

This process is repeated for a pull down transistor model based on an actual pull down transistor to be modeled (FIG. 3), and a pass gate transistor based on an actual pass gate transistor to be modeled (FIG. 4).

The pull up, pull down, and pass gate transistor models are then connected as shown in FIG. 1 to produce an SRAM model. It might be expected that the operational characteristics of this SRAM model would be in accordance with the operational characteristics of the SRAM cell being modeled. However, this is normally not the case, due to the presence of the cross-coupled inverter in feedback. For example, currents through the model during the read and/or write operations may not match those corresponding currents of the actual cell. Furthermore, the static noise margin (SNM) of the cell model, a figure of merit for stability of the cell, may fall short of the cell. In addition, during measurement of critical read current curve, when measured current is at its peak value corresponding to Icrit read, the pull down transistor is in the linear region of operation and the pass gate is in the saturation region of operation, while during measurement of write current, when write current is at its peak, the pull up is in the linear region while the pass gate is in the saturation region (see FIGS. 2, 3 and 4). While overall matching was achieved as described above, no effort has been made in the prior art to achieve a high degree of matching in these particular regions for these particular transistor models.

In addition, known modeling techniques are insufficient because they do not consider yield analysis when generating compact models and thus are unable to provide a complete picture of existing variations in the SRAM process. Furthermore, known approaches do not use an analytical approach to back track variations seen in the actual product. Lastly, known approaches are insufficient since they are unable to predict product behavior for future technology nodes because of uncertainties in the modeling methodology.

Therefore, what is needed is a method of modeling an SRAM cell that overcomes the above problems.

### SUMMARY OF THE INVENTION

Broadly stated, the present method of modeling an SRAM cell comprises modeling transistors based on transistor devices to provide transistor models, providing an SRAM cell model including the so provided transistor models, matching an operational characteristic of the SRAM cell model with a corresponding operational characteristic of an SRAM cell, again modeling the previously-modeled transistors based on the transistor devices to provide again-modeled transistor models, and providing an SRAM cell model including the again-modeled transistor models.

Further broadly stated, the present invention is a method of modeling an SRAM cell comprising providing an SRAM cell model including transistor models, varying at least one parameter of a transistor model of the SRAM cell model, and running a simulation based on the SRAM cell model.

The present invention is better understood upon consideration of the detailed description below, in conjunction with the accompanying drawings. As will become readily apparent to those skilled in the art from the following description, there is shown and described an embodiment of this invention simply by way of the illustration of the best mode to carry out the invention. As will be realized, the invention is capable of other embodiments and its several details are capable of modifications and various obvious aspects, all without departing from the scope of the invention. Accordingly, the drawings and detailed description will be regarded as illustrative in nature and not as restrictive.

### BRIEF DESCRIPTION OF THE DRAWINGS

The novel features believed characteristic of the invention are set forth in the appended claims. The invention itself, however, as well as said preferred mode of use, and further objects and advantages thereof, will best be understood by reference to the following detailed description of an illustrative embodiment when read in conjunction with the accompanying drawings, wherein:

FIG. 1 is a schematic illustration of a typical prior art SRAM cell;

FIGS. 2, 3 and 4 are graphs illustrating prior modeling of a pull up transistor, a pull down transistor, and a pass gate respectively;

FIG. 5 is a flow chart illustrating aspects of the present invention; and

FIGS. 6-11 illustrate procedures set out in the flow chart of FIG. 5.

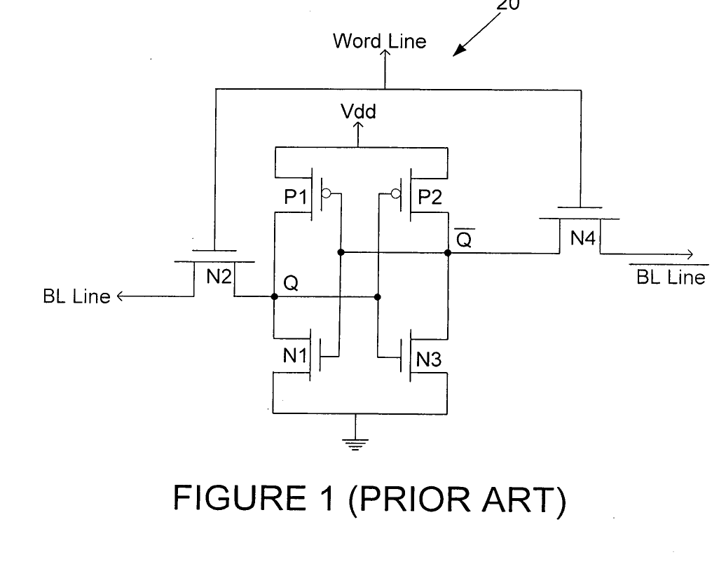

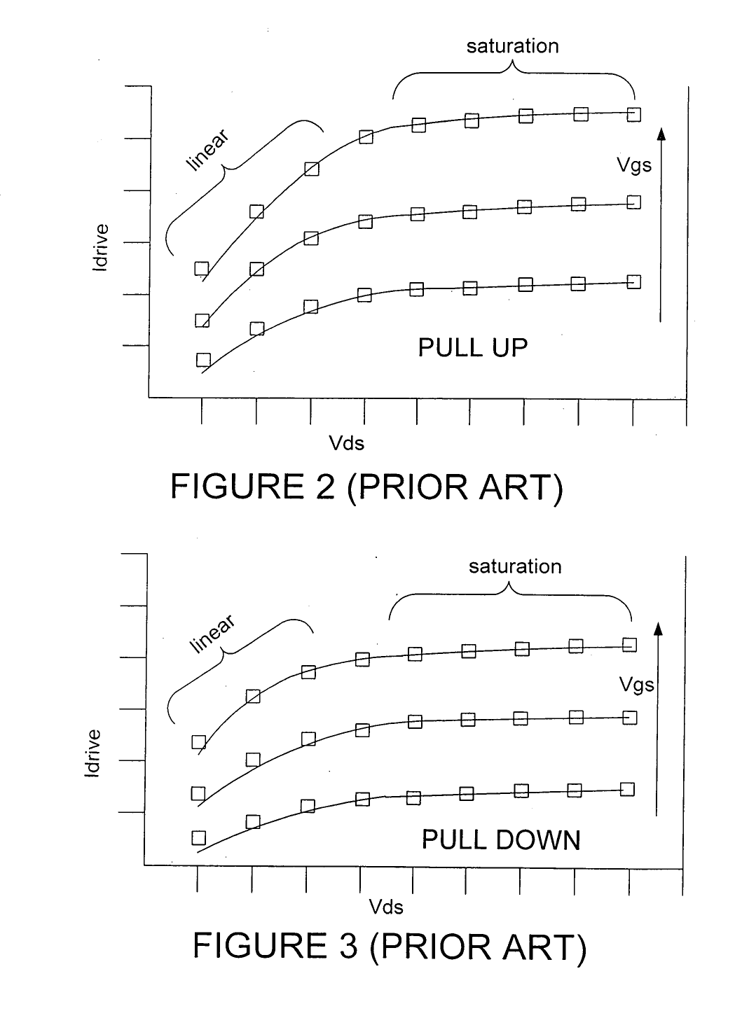

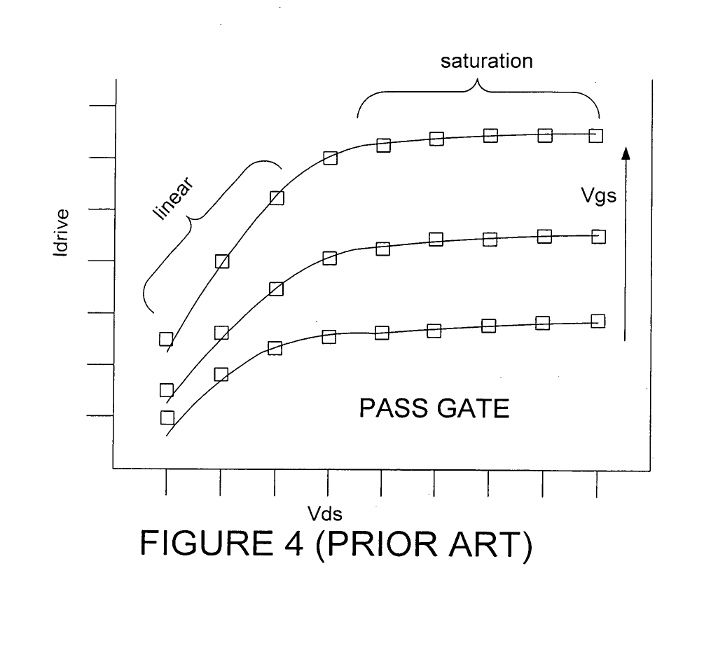

### DETAILED DESCRIPTION

Reference is now made in detail to a specific embodiment of the present invention which illustrates the best mode presently contemplated by the inventors for practicing the invention.

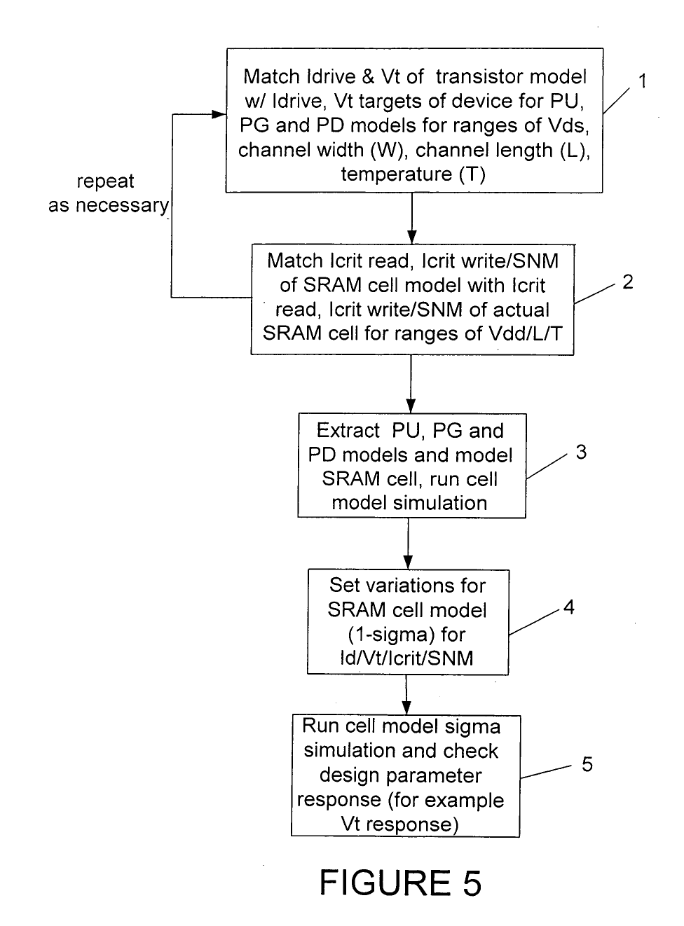

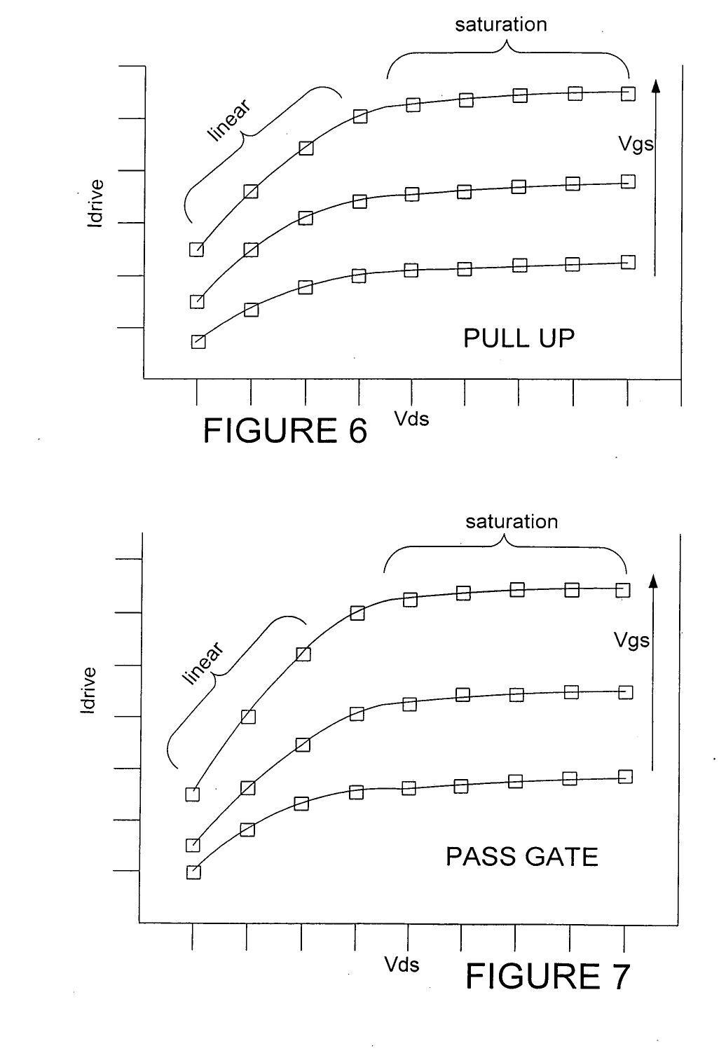

With reference to FIG. 5, initially, as in the prior art, modeling an SRAM cell (for example cell 20) starts with the modeling of the transistors thereof. As described above, for example, in modeling a pull up transistor, using selected data (for example current-voltage (IV) operational characteristics) taken from an actual pull up transistor to be modeled, one loads this data into a software program which also contains a (public domain) transistor model. Parameters of the transistor model are then varied with the goal of having the model operational characteristics match those corresponding operational characteristics of the actual transistor (Box 1 of FIG. 5). In particular, the Idrive (Id) and Vt characteristics of the transistor model are matched with the Idrive and threshold voltage Vt targets of the pull up transistor for ranges of Vds, channel width W, channel length L, and temperature T. FIG. 6 shows this matching for a pull up device and model for particular values of W, L and T. Since the pull up transistors in an SRAM cell operate in the linear region as described above, particular attention is paid to the matching of this operational characteristic in the model and device (FIG. 6).

This process is then repeated for a pass gate transistor model based on an actual pass gate transistor to be modeled (FIG. 7). Since the pass gate transistors in an SRAM cell operate in the saturation region as described above, particular attention is paid to the matching of this operational characteristic in the model and device.

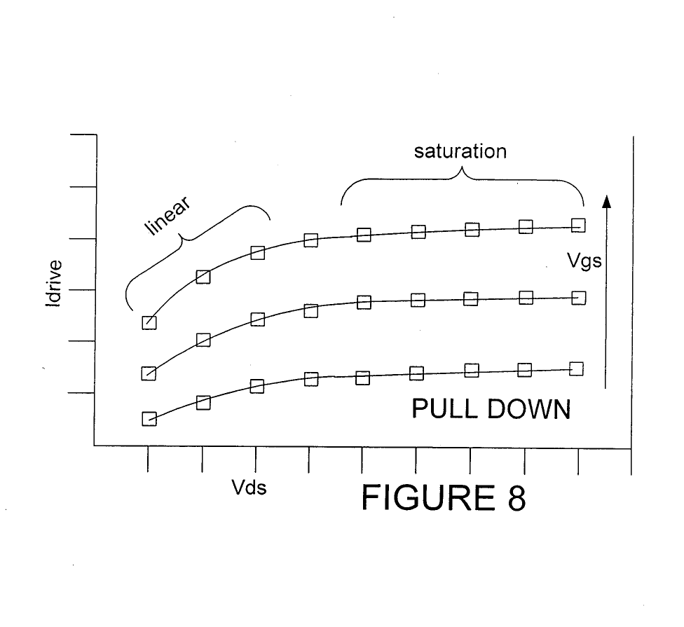

This process is then repeated for a pull down transistor model based on an actual pull down transistor to be modeled (FIG. 8). Since the pull down transistors in an SRAM cell operate in the linear region as described above, particular attention is paid to the matching of this operational characteristic in the model and device.

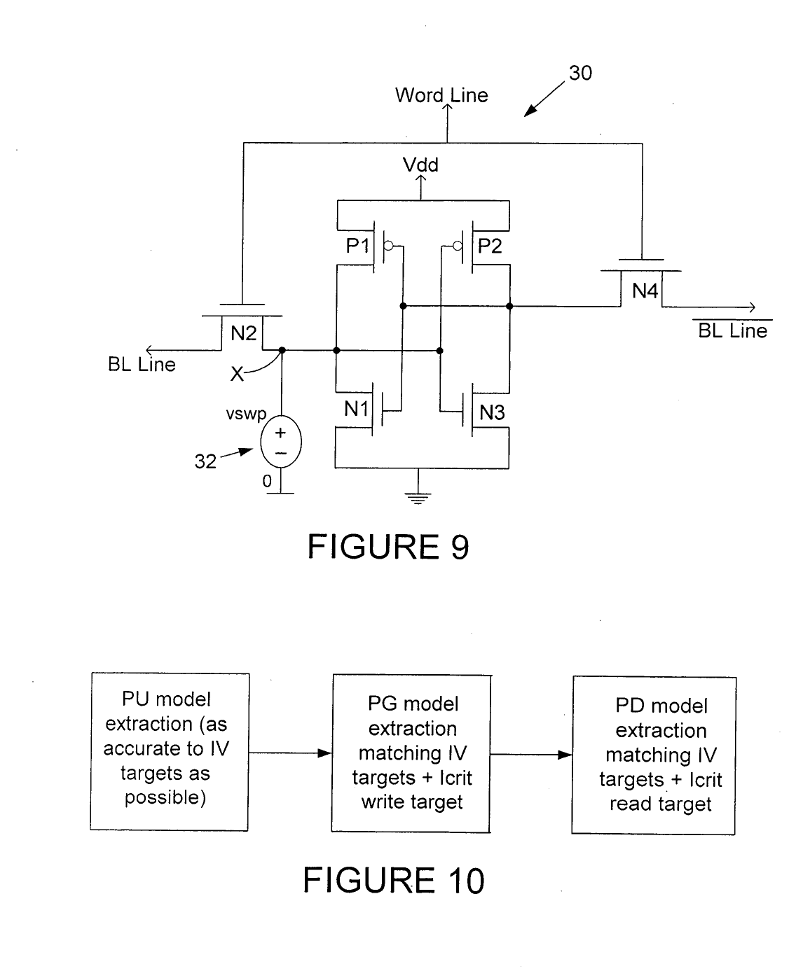

As mentioned above, at this point in the procedure, currents through an SRAM model including these transistor models during the read and/or write operations may not match those corresponding currents of the actual cell. Furthermore, the static noise margin (SNM) of the cell model may fall short of the SNM of the cell. Consequently (Box 2 of FIG. 5), at this point, the pull up, pull down, and pass gate transistor models are then connected in model form to produce an SRAM model 30 (FIG. 9). In the read operation undertaken on the cell model 30, a voltage source 32 is provided as shown, and during the read operation the voltage provided by the voltage source 32 is swept up from 0 to Vdd. During this operation, the level of current through transistor N1 is monitored (at node X), with Icrit read being the peak current value measured. A measurement of corresponding Icrit read for the SRAM cell 20 is then undertaken.

A similar operation is undertaken to determine Icrit write during the write operation for the SRAM model 30, and measurement of corresponding Icrit write for the SRAM cell 20 is undertaken.

Also, measurement and comparison of SNM for the cell model 30 and cell 20 are undertaken.

If Icrit read for the cell model 30 does not match Icrit read for the cell 20, and/or Icrit write for the cell model 30 does not match Icrit write for the cell 20, and/or SNM for the cell model 30 does not match SNM for the cell 20, parameters of the transistor models are varied to provide these matches for ranges of Vdd, L and T. With these matches achieved, matches achieved in the procedure of Box 1 of FIG. 5 may be lost. In that case, the procedures of Box 1 of FIG. 5 would be repeated. Repetitions of the procedures of Boxes 1 and 2 of FIG. 5 are repeated as necessary until the matches of both Box 1 and Box 2 are achieved.

The modeling of the transistors is done in the order shown in FIG. 10 for maximum efficiency. First the pull up transistor model is extracted, matched as accurately as possible to IV targets. Then the pass gate transistor model is extracted, matched as accurately as possible to IV targets and Icrit write target (determined by pull up and pass gate transistors). Next the pull down transistor model is extracted, matched as accurately as possible to IV targets and Icrit read target (determined by pull down and pass gate transistors). The SRAM model 30 is then produced based on these extractions, and the SRAM model simulation is run (Box 3 of FIG. 5). This approach streamlines the overall modeling operation and minimizes the number of transistor modeling iterations needed.

In the ideal case, fabricated SRAM cells will be as in the model 30 across an entire array, across die and across wafers. However, the transistors of fabricated cells are subject to process induced variations which cannot be controlled. For example, a series of corresponding transistors from over a number of such cells may have slightly different channel lengths or threshold voltages from cell to cell, causing different operating characteristics. Consequently it is desirable to build these variations into the SRAM model so that one will know how the fabricated cell will perform with these random variations.

In furtherance thereof, over a number of such cells, corresponding transistors are measured for parameters such as Idsat, Vdsat, Vtlin and other electrical performance characteristics as chosen. For a given set of corresponding transistors from cell to cell, this provides a Gaussian distribution for each of these measured parameters. Then, using propagation of variance techniques on that data, Gaussian distributions for channel length L, channel width W and threshold voltage Vt of that modeled transistor are provided, which may be varied to capture in the model the various performance parameters in the actual transistors. This is done for all six transistors in such a cell. Once this has been done, by varying L, W and Vt, one can describe in the model variations in the electrical performance characteristics, including Idrive (Id) and Vt, with a high degree of accuracy. Once these variations have been done for Id and Vt, the model is expected to line up with Icrit and SNM variations.

As distributions of L, W and Vt are assumed to be Gaussian, one can fully describe the Gaussian distribution of any of these by median (the model of Box 3 of FIG. 5) and 1-sigma.

With the variations now known for the transistors of the median model, one can provide distributions for Id, Vt, Icrit and SNM (1-sigma) for the model and set variations therefore (Box 4 of FIG. 5). Then a large number of Monte Carlo simulations are run to see how model simulation compares with the actual measured data points for the purpose of matching data distribution with simulation distribution.

With reference to Box 5 of FIG. 5, knowing the median and variations of the cell model, the question of yield is addressed, i.e., what must be done to L, W and/or Vt in the transistors of the model to make the cell fail in operation, so that one knows failure points before the product is manufactured. Using a standard mathematical approach, after selecting values for L, W and Vt for each of the six transistors, for example at the respective median values thereof, a “fastest descent to failure” approach is used to establish the failure point. This is repeated for every nominal starting design point for L, W and Vt (i.e., for example, if Vt is changed from the original setting, the cell will fail in a different manner). This model aims to describe all the different scenarios, i.e., not only from a median sense, or from variations in transistors, but also the path to failure. This results in design options for L, W and Vt of the cell.

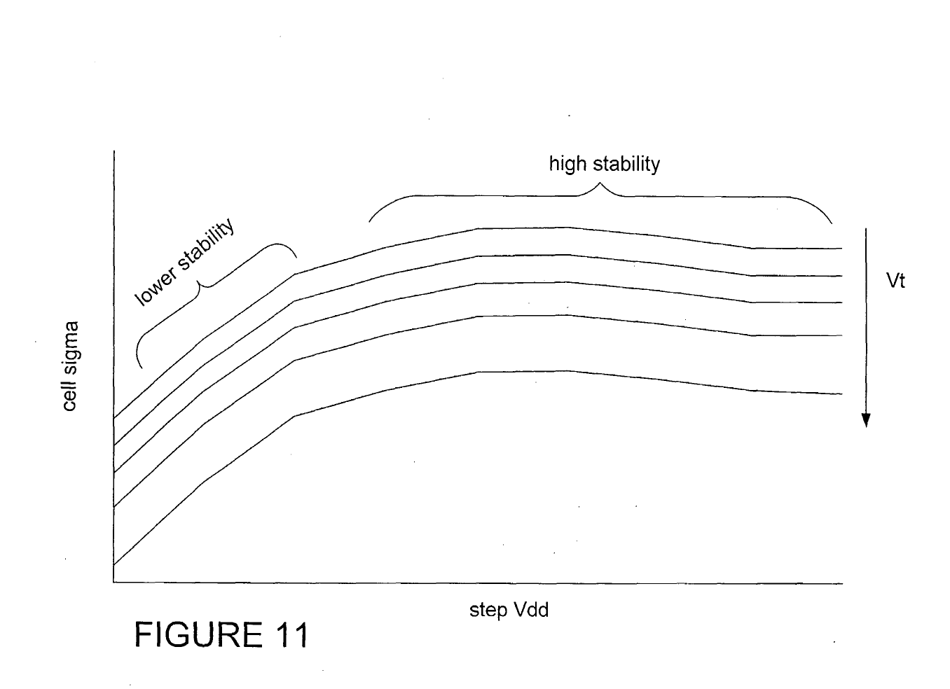

Cell sigma is a measure of how much variation the cell model can handle before failure, i.e., cell stability. The graph of FIG. 11 illustrates cell sigma vs. stepped Vdd for various values of Vt, in a pull down device, with higher cell sigma indicating higher cell stability. As noted, lower Vt results in higher cell stability, while cell stability remains fairly constant for higher levels of Vdd but drops when Vdd drops below a certain level. Consequently one can choose a high value which still provides high cell sigma, so as to decrease Vdd to the lowest level practical as shown in FIG. 11 so as to achieve low power consumption. If one goes out to 5-sigma, probability of failure is 1 in about 1,000,000 cells. It will be seen that with different parameters (in this example Vt), one can reach the selected stability level at different Vt settings, with Vdd depending on the Vt setting. This can be done for any design point of transistor parameters. In essence, FIG. 11 indicates the voltage of operation required to ensure that the design has no failures in this example.

Through the above approach, a method of delivering robust compact models for an SRAM is provided. These models provide accurate information about cell currents and stability which have become crucial for a robust bit-cell design.

The foregoing description of the embodiment of the invention has been presented for purposes of illustration and description. It is not intended to be exhaustive or to limit the invention to the precise form disclosed. Other modifications or variations are possible in light of the above teachings.

The embodiment was chosen and described to provide the best illustration of the principles of the invention and its practical application to thereby enable one of ordinary skill of the art to utilize the invention in various embodiments and with various modifications as are suited to the particular use contemplated. All such modifications and variations are within the scope of the invention as determined by the appended claims when interpreted in accordance with the breadth to which they are fairly, legally and equitably entitled.

What is claimed is:

1. A method of modeling an SRAM cell comprising:
modeling transistors based on transistor devices to provide transistor models;
providing an SRAM cell model including the so provided transistor models;
matching an operational characteristic of the SRAM cell model with a corresponding operational characteristic of an SRAM cell;
again modeling the previously-modeled transistors based on the transistor devices to provide again-modeled transistor models; and
providing an SRAM cell model including the again-modeled transistor models.

2. The method of claim 1 wherein the operational characteristic is a current.

3. The method of claim 2 wherein the operational characteristic is a read current.

4. The method of claim 2 wherein the operational characteristic is a write current.

5. The method of claim 1 wherein the operational characteristic is static noise margin (SNM).

6. A method of modeling an SRAM cell comprising in the following order:
modeling a pull up transistor based on a pull up transistor device to provide a pull up transistor model;
modeling a pass gate transistor based on a pass gate transistor device to provide a pass gate transistor model;
modeling a pull down transistor based on a pull down transistor device to provide a pull down transistor model; and
providing an SRAM cell model including the transistor models.

7. The method of claim 6 wherein at least one of the transistor models is modeled primarily on a particular operational characteristic of the transistor device on which it is modeled.

8. The method of claim 7 wherein the pull down transistor model is modeled primarily on the linear operating characteristics of the pull down transistor device.

9. The method of claim 7 wherein the pull up transistor model is modeled primarily on the linear operating characteristics of the pull up transistor device.

10. The method of claim 7 wherein the pass gate transistor model is modeled primarily on the saturation operating characteristics of the pass gate transistor device.

11. The method of claim 7 wherein the pull down transistor model is modeled primarily on the linear operating characteristics of the pull down transistor device, the pull up transistor model is modeled primarily on the linear operating characteristics of the pull up transistor device, and the pass gate transistor model is modeled primarily on the saturation operating characteristics of the pass gate transistor device.

12. A method of modeling an SRAM cell comprising:
providing an SRAM cell model including transistor models;
varying at least one parameter of a transistor model of the SRAM cell model, and
running a simulation based on the SRAM cell model.

13. The method of claim 12 wherein a plurality of transistor model parameters are varied.

14. The method of claim 12 wherein the step of varying at least one parameter of a transistor model of the SRAM cell model comprises varying the channel length of the transistor model.

15. The method of claim 12 wherein the step of varying at least one parameter of a transistor model of the SRAM cell model comprises varying the channel width of the transistor model.

16. The method of claim 12 wherein the step of varying at least one parameter of a transistor model of the SRAM cell model comprises varying the threshold voltage of the transistor model.

17. The method of claim 12 wherein varying at least one parameter of a transistor model of the SRAM cell model causes the SRAM cell to fail in operation when running a simulation based on the SRAM model.
